(19) United States
(12) Patent Application Publication
(10) Pub. No.: US 2020/0149534 A1
(43) Pub. Date: May 14, 2020

(54) ELECTRIC DRIVE AND TRANSMISSION FOR A MOTOR VEHICLE

(71) Applicant: ZF Friedrichshafen AG, Friedrichshafen (DE)

(72) Inventor: Michel Wetterau, Meersburg (DE)

(21) Appl. No.: 16/680,644

(22) Filed: Nov. 12, 2019

(30) Foreign Application Priority Data
Nov. 13, 2018 (DE) 10 2018 219 359.2

(51) Int. Cl. F04D 13/06; H02K 11/33; H02K 9/22; H02K 5/16; H02K 7/116; H02K 11/02

(52) U.S. Cl. CPC F04D 13/0606; H02K 11/33; H02K 9/22; B60K 17/10; H02K 7/116; H02K 11/02; H02K 5/16

(57) ABSTRACT

An electric drive unit (E) may include an electric motor (EM) and an electronic control unit (EE) for the open-loop control of the electric motor (EM). The electric motor (EM) has a stator unit (S) and a rotor (R). The electronic control unit (EE) is mounted on an electrically insulating carrier element (ET), where the carrier element (ET) is attached to the stator unit (S). Additionally, the stator unit (S) includes a stator core (SP), where the stator core (SP) is electrically conductively connected to a ground connection (EEG) of the electronic control unit (EE).

### CROSS-REFERENCE TO RELATED APPLICATION

The present application is related and has right of priority to German Patent Application No. 10 2018 219 359.2 filed on Nov. 13, 2018, the entirety of which is incorporated by reference for all purposes.

### FIELD OF THE INVENTION

The present invention relates generally to an electric drive, for example, for driving a pump. The invention further relates to a transmission for a motor vehicle having such a drive unit.

### BACKGROUND

A plurality of electric drive units is known from the prior art. For example, EP 2 623 784 A2 describes an electric oil pump system having a brushless electric motor and an integrated electronic control unit. The electronic control unit is attached to a housing section of the electric motor, wherein the housing section is made of plastic.

Application DE 10 2017 213 412.7, which is still unpublished, describes an oil pump drive device having an electric motor. A stator of the electric motor is surrounded, at least in sections, by a plastic mass. An electronic control unit for the open-loop control of the electric motor is attachable to the plastic mass.

Typically, electric motors are operated in a clocked manner, so that a power supply to the electric motor is switched at a high frequency in the control unit. This can result in electromagnetic interference signals, which are inductively and/or capacitively transmitted to adjacent electrically conductive elements. In the case of a configuration of the type represented in the prior art, the control unit is electrically insulated with respect to the electric motor, so that an electric feedback of the interference signals to the control unit is adversely affected. As a result, the interference signals can propagate and, for example, interfere with the function of a further control unit, which is undesirable.

The problem addressed by the invention is therefore that of providing an electric drive, which is distinguished by a lower emission of interference signals.

### SUMMARY OF THE INVENTION

As the solution to the problem, an electric drive unit or “electric drive” is provided, which includes an electric motor and an electronic control unit for actuating the electric motor. The electric motor has a stator unit and a rotor. The electronic control unit is mounted on an electrically insulating carrier element, for example, on a printed circuit board carrier made of plastic. The carrier element is attached to the stator unit of the electric motor. The stator unit has a stator core, which is electrically conductively connected to the ground connection of the electronic control unit.

Due to this type of approach, an electric current, which is capacitively and/or inductively passed into the stator core via the interference signals of the electronic control unit, can flow back to the electronic control unit on a short path. As a result, a further propagation of the interference signals is reduced in an easy way.

Preferably, a metallic heat sink is provided for cooling the electronic control unit. The heat sink is connected to the electronic control unit in a manner having good thermal conductivity. A ground connection of the electronic control unit is electrically conductively connected to the heat sink, so that the voltage level of the heat sink is defined in relation to the electronic control unit.

Preferably, the electrically conductive connection between the stator core and the ground connection extends across or through the heat sink. An electrically conductive connection between the stator core and the heat sink is established in a simple and reliable manner. In addition, such a solution avoids an increase of the outlay required for the production and the equipping of the electronic control unit.

Preferably, the electrically conductive connection between the stator core and the heat sink is formed by an electrical conductor provided specifically for this purpose. In other words, the electrically conductive connection serves no other purpose than to establish the electrically conductive connection. The connection is, for example, one or more metallic sheet-metal strips or wire sections, which are attached to the stator core and the heat sink.

Preferably, the carrier element is spatially situated between the heat sink and the stator unit.

Preferably, the rotor of the electric motor is connected to a rotor shaft. The rotor shaft is rotatably mounted in a metallic bearing carrier of the drive unit, wherein the bearing carrier is electrically insulated from the stator core. Due to the insulation of the bearing carrier from the stator core, a current induced into the stator core cannot flow into the bearing carrier. As a result, a propagation of the interference signals is reduced.

According to an embodiment, the carrier element, together with the electronic control unit, is situated between the stator unit and the bearing carrier, wherein the electronic control unit is preferably situated on the front-side of the carrier element that faces the bearing carrier. Such an arrangement results in a better thermal insulation between the electric motor and the electronic control unit, so that the electronic control unit is heated by the electric motor to a lesser extent.

In the case of such an embodiment, it is advantageous to directly connect the bearing carrier to the electronic control unit in a manner having good thermal conductivity. As a result, the bearing carrier operates as a heat sink of the electronic control unit; a separate heat sink can therefore be omitted.

According to a preferred embodiment, the stator unit has an electrically insulating molding compound, which at least partially encloses the stator core. The carrier element is attachable to the molding compound, for example, with the aid of a bolted connection. Such an embodiment allows for an embodiment of the electric motor without a separate housing. As compared to an approach having a separate housing, the electric motor can therefore be larger such that the maximum possible power of the electric motor can be increased.

The stator core is electrically insulated from the bearing carrier by the molding compound. Alternatively, the stator core is insulated from the bearing carrier by a separate electrically insulating separating element, for example, by a plastic disk between the stator unit and the bearing carrier. According to a further alternative, the stator core is insulated from the bearing carrier by the carrier element. All these variants reduce the propagation of a current, which is passed into the stator core by the interference signals, towards the bearing carrier.

According to a preferred embodiment, the electric motor has an internal rotor, wherein the stator unit does not have a housing. In particular, the stator unit does not have a metallic housing. Such an embodiment reduces the installation space required for the electric drive unit but is unfavorable with respect to the propagation of interference signals. Due to the embodiment according to the invention, this disadvantage is at least partially compensated for, however.

The electric drive unit is a pump drive. The electric drive unit is a component of a transmission for a motor vehicle, for example, for driving a pump of the transmission. Since a motor vehicle transmission usually has further electric and electronic components, care must be taken to ensure a low emission of interference signals with respect to such an application. The electric drive unit according to the invention is therefore suitable, in particular, for use in the motor vehicle transmission.

### BRIEF DESCRIPTION OF THE DRAWINGS

Exemplary embodiments of the invention are described in detail in the following with reference to the attached figures. Wherein:

FIG. 1 shows a first exemplary embodiment of an electric drive unit;

FIG. 2 shows a second exemplary embodiment of an electric drive unit;

FIG. 3 shows a third exemplary embodiment of an electric drive unit;

FIG. 4 shows a fourth exemplary embodiment of an electric drive unit;

FIG. 5 shows a fifth exemplary embodiment of an electric drive unit;

FIG. 6 shows an embodiment of a transmission having an electric drive;

FIG. 7 shows another embodiment of a transmission having an electric drive; and

FIG. 8 shows a further embodiment of a transmission having an electric drive.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

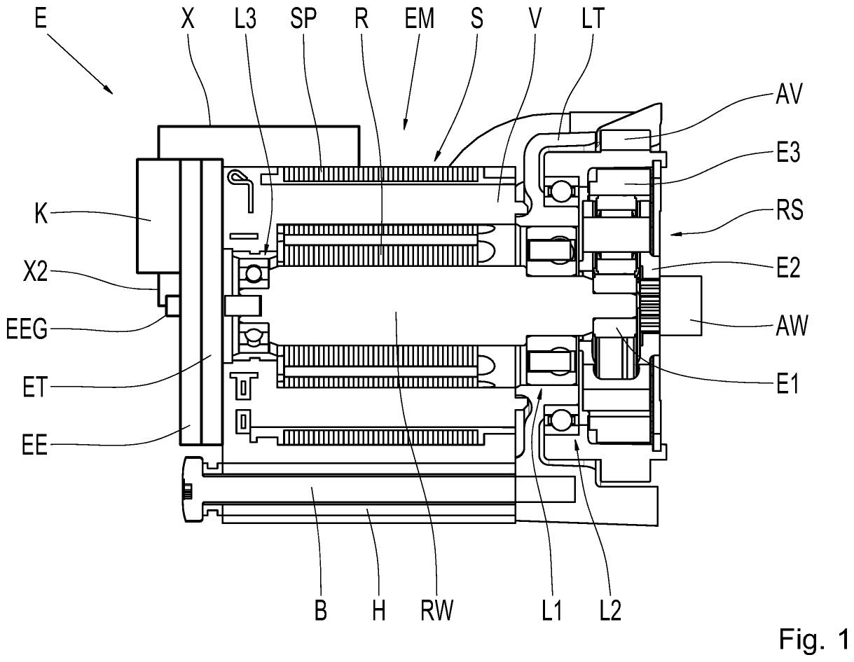

FIG. 1 shows a sectional view through an electric drive unit E according to a first exemplary embodiment. The electric drive unit E has an oil pump drive shaft AW, a planetary gear set RS, a bearing carrier LT, and an electric motor EM. The planetary gear set RS has a first element E1, a second element E2, and a third element E3. The first element E1 is associated with a sun gear of the planetary gear set RS. The second element E2 is associated with a planet carrier of the planetary gear set RS. The third element E3 is associated with a ring gear of the planetary gear set RS. Multiple planet gears, which intermesh with the sun gear as well as with the ring gear, are rotatably mounted on the planet carrier.

The first element E1, i.e., the sun gear of the planetary gear set RS, is connected to a rotor shaft RW, which is connected to a rotor R of the electric motor EM. The second element E2, i.e., the planet carrier of the planetary gear set RS, is connected to the oil pump drive shaft AW. The third element E3, i.e., the ring gear of the planetary gear set RS, is drivable by a drive source, which is located outside the electric drive unit E. An external gearing AV, which is connected to the third element E3, i.e., to the ring gear of the planetary gear set RS, is provided for this purpose. With the aid of the external gearing AV, the third element E3 is drivable from the outside, for example, with the aid of a gearwheel or a chain.

A bearing carrier LT is associated with the planetary gear set RS for the mounting thereof. A first bearing L1 is supported on the bearing carrier LT, with the aid of which the first element E1, i.e., the sun gear of the planetary gear set RS, is rotatably mounted. The mounting of the sun gear E1 takes place via the rotor shaft RW. The sun gear E1 is supported in the radial direction by the first bearing L1. Moreover, a second bearing L2 is supported on the bearing carrier LT, with the aid of which the ring gear E3 of the planetary gear set RS is mounted. The bearing carrier LT at least partially encloses the planetary gear set RS.

The electric motor EM includes a stator unit S. The stator unit S has a stator core SP, which is provided for accommodating a stator winding. The stator core SP is surrounded, in sections, by a molding compound V. In the embodiment according to the representation in FIG. 1, the stator core SP is partially exposed, i.e., is not completely surrounded by the molding compound V. The stator core SP is fixed in position by the molding compound V. The stator unit S is attached to the bearing carrier LT with the aid of the molding compound V. For example, the electric drive unit E has multiple bolts B, the free end of which includes a thread. The thread cooperates with a thread formed in the bearing carrier LT. Sleeves H are arranged in the molding compound V, into each of which one of the bolts B has been guided. The rotor R and the stator unit S of the electric motor EM do not have a separate housing. Instead, they protrude from the bearing carrier LT. The rotor shaft RW is rotatably mounted with the aid of the first bearing L1 and with the aid of a third bearing L3. The third bearing L3 is supported in the molding compound V with the aid of a bearing sleeve.

An electronic control unit EE, which is attached to an electrically insulating carrier element ET, is provided for actuating the electric motor EM. The carrier element ET is attached to the stator unit S, for example, with the aid of a clip connection or a bolted connection. In the exemplary embodiment according to FIG. 1, the carrier element ET is attached to the molding compound V. A heat sink K, which is connected to at least one component of the electronic control unit EE in a manner having good thermal conductivity, is provided for cooling the electronic control unit EE. A ground connection EEG of the electronic control unit EE is electrically conductively connected to the heat sink K via a conductor X2. The conductor X2 and the ground connection EEG are only schematically represented in FIG. 1. The conductor X2 is, for example, a spring element attached to the electronic control unit EE and, due to its spring stiffness, contacts the heat sink K.

An electrical conductor X establishes an electrically conductive connection between the stator core SP and the heat sink K. The conductor X is only schematically represented in FIG. 1. The conductor X is, for example, a wire section or a sheet metal strip. The conductor X fulfills no other function than to establish the electrically conductive connection. A current, which is inductively and/or capacitively passed or transmitted from the electronic control unit EE into the stator core SP, can flow through the conductor X, via the heat sink K and the conductor X2, back to the electronic control unit EE. Since the stator core SP is electrically insulated from the bearing carrier LT by the molding compound V, the current coupled into the stator core SP cannot flow to the bearing carrier LT. Due to the spatial separation between the electronic control unit EE and the bearing carrier LT, no significant current is passed into the bearing carrier LT.

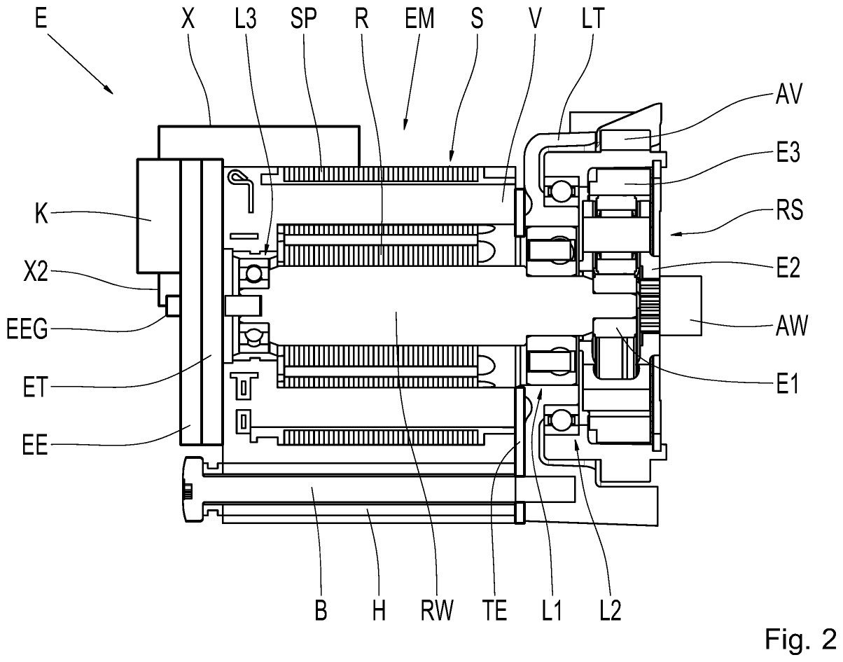

FIG. 2 shows an electric drive unit E according to a second exemplary embodiment, which essentially corresponds to the first exemplary embodiment represented in FIG. 1 except that, in this case, an electrically insulating separating element TE is additionally provided between the stator unit S and the bearing carrier LT. As a result, it is ensured that an electrically conductive path is not formed between the stator core SP and the bearing carrier LT, for example, due to exposed interconnection ends on the stator unit S or due to parasitic losses. The separating element TE is, for example, a plastic disk.

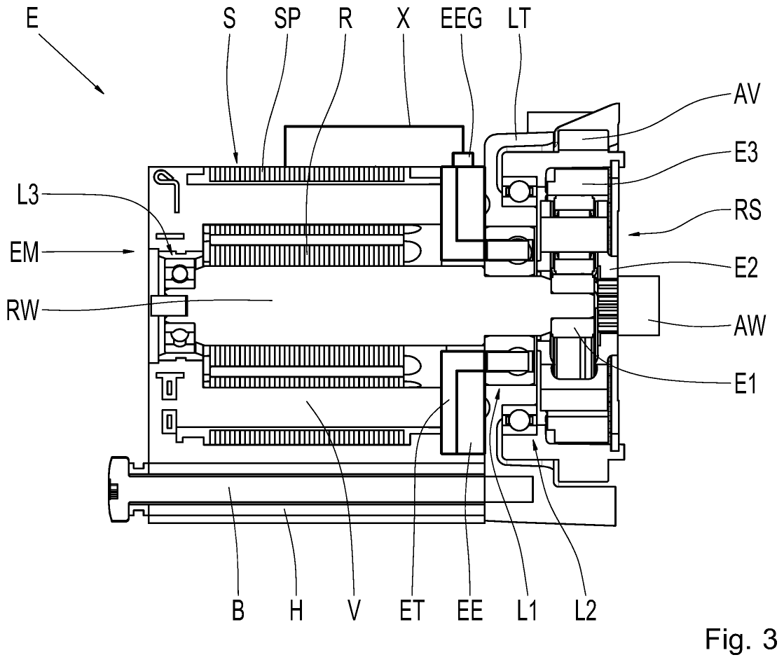

FIG. 3 shows an electric drive unit E according to a third exemplary embodiment, which essentially corresponds to the first exemplary embodiment represented in FIG. 1 except that, in this case, the carrier element ET, including the electronic control unit EE, is arranged between the bearing carrier LT and the stator unit S. The carrier element ET and the electronic control unit EE are therefore disk-shaped and have a central open area for the passage of the rotor shaft RW. The electronic control unit EE is arranged on the front-side of the carrier element ET closest to the bearing carrier LT. In this type of embodiment, a separate heat sink is not necessary for cooling the electronic control unit EE; instead, the bearing carrier LT operates as a heat sink. For this purpose, the bearing carrier LT is directly connected to or in contact with the electronic control unit EE in a manner having good thermal conductivity. The conductor X is only schematically represented. The conductor X could be, for example, a spring element attached to the electronic control unit EE and, due to its spring stiffness, contacts the stator core SP, for example, through an opening formed in the carrier element ET.

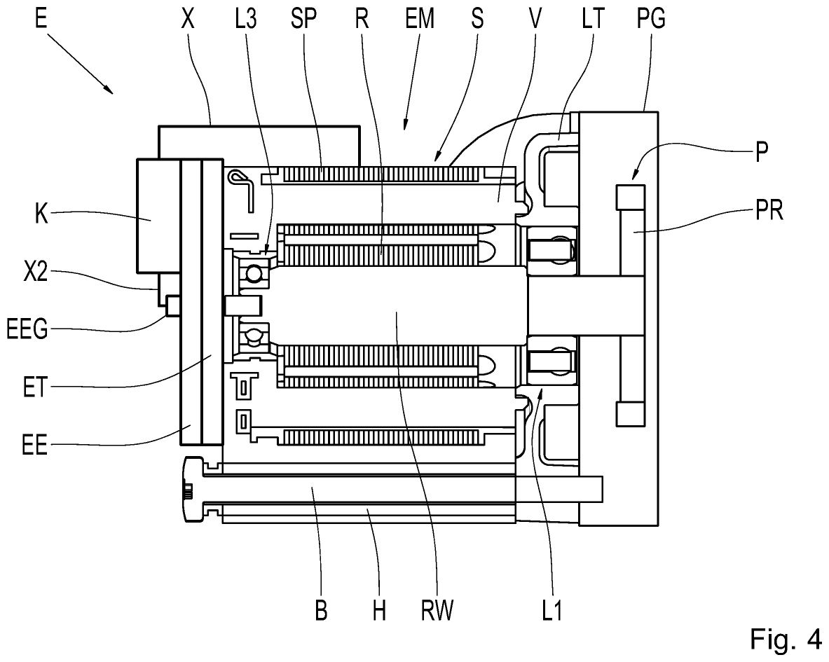

FIG. 4 shows an electric drive unit E according to a fourth exemplary embodiment, which essentially corresponds to the first exemplary embodiment represented in FIG. 1 except that the gear set RS is omitted in this exemplary embodiment, such that the rotor shaft RW is directly connected to an impeller PR of a pump P. The pump P is arranged in a pump housing PG, which is connected to the bearing carrier LT. The stator unit S is fixedly bolted to the pump housing PG via the bearing carrier LT with the aid of the bolts B.

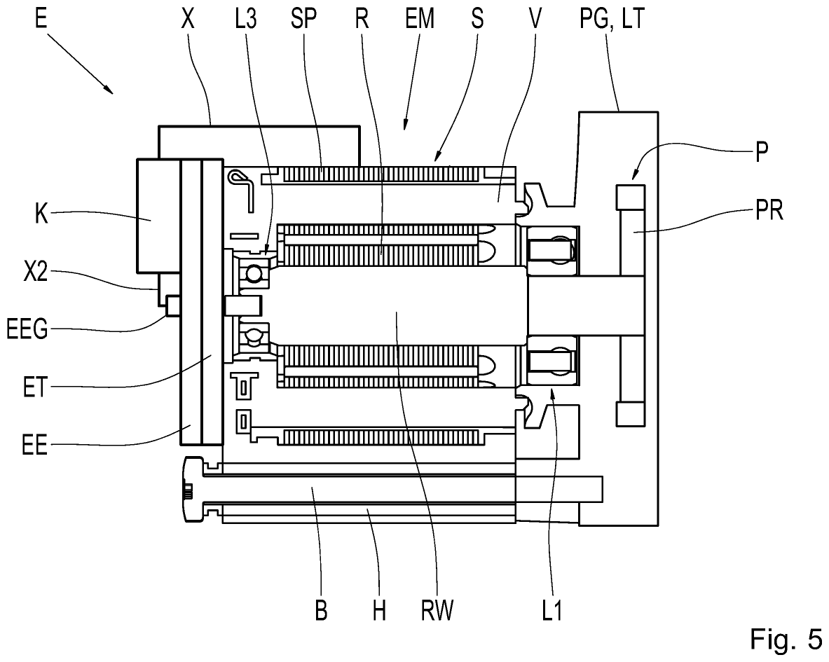

FIG. 5 shows an electric drive unit E according to a fifth exemplary embodiment, which essentially corresponds to the fourth exemplary embodiment represented in FIG. 4 except that the bearing carrier LT is integral with the pump housing PG in this case.

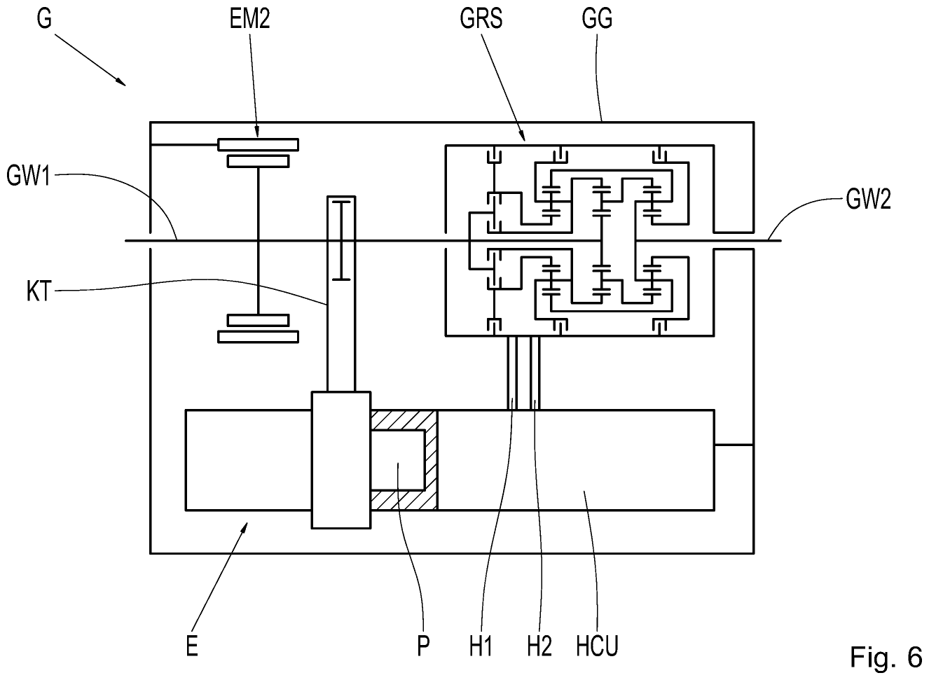

FIG. 6 shows a schematic of a transmission G for a motor vehicle. The transmission G has an input shaft GW1, an output shaft GW2, and a transmission gear set GRS in a housing GG. The transmission gear set GRS is configured for implementing different transmission ratios between the input shaft GW1 and the output shaft GW2. For this purpose, planetary gear sets of the transmission gear set GRS cooperate with hydraulically actuated shift elements. The transmission G includes a pump P, which is connected to a hydraulic control unit HCU, for supplying pressure to the shift elements. The hydraulic control unit HCU has multiple valves, which are not represented in FIG. 6. The hydraulic control unit HCU is connected to the transmission gear set GRS, or to the shift elements located therein, via the hydraulic lines H1, H2. More than two hydraulic lines may instead be provided. The pump P is arranged within the hydraulic control unit HCU. Oil is conveyed to the valves of the hydraulic control unit HCU via driving of the pump P.

The transmission G includes an electric drive unit E according to one of the first three exemplary embodiments, wherein an impeller of the pump P, similar to the impeller PR shown in FIGS. 4 and 5, is connected to the oil pump drive shaft AW. The pump P is therefore drivable by the electric motor EM of the electric drive unit E or by the input shaft GW1. For this purpose, the input shaft GW1 is connected to the third element E3 of the planetary gear set RS via a sprocket KT and via the external gearing AV. The input shaft GW1 is driven by either a transmission-external internal combustion engine connected to the input shaft GW1 or with the aid of an electric machine EM2, whose rotor is connected to the input shaft GW1. The electric machine EM2 is arranged within the transmission housing GG, by way of example. Alternatively, the electric machine EM2 is arrangeable outside the transmission housing GG.

If the pump P is driven by the input shaft GW1, a supporting torque is to be applied at the planetary gear set RS, so that power is transmittable via the planetary gear set RS. The supporting torque is made available, for example, via a freewheel unit or via the electric motor EM of the electric drive unit E.

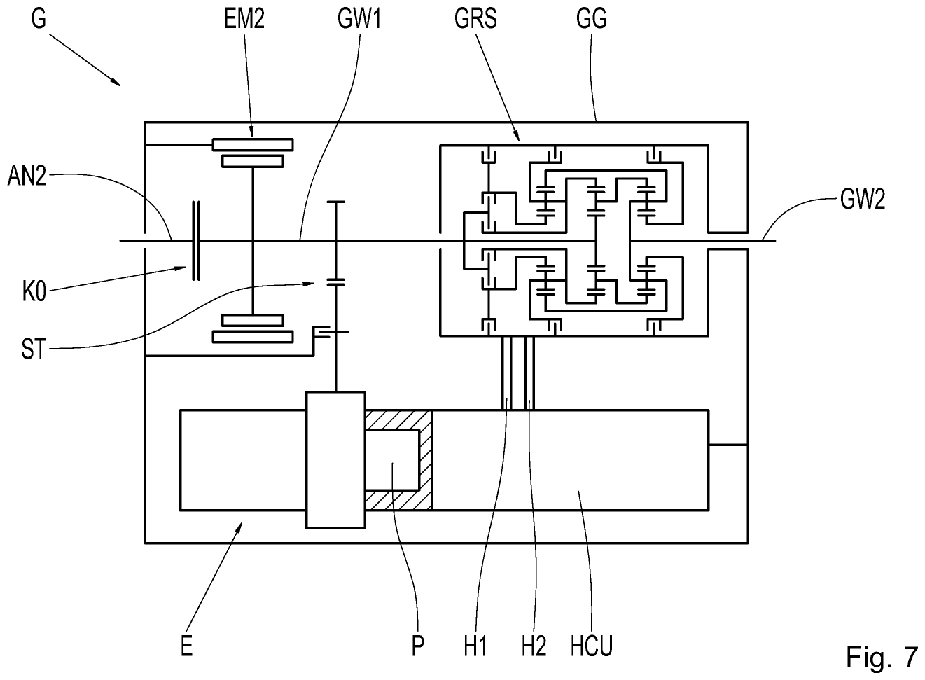

FIG. 7 shows a schematic of a transmission G for a motor vehicle, which essentially corresponds to the transmission represented in FIG. 6 except that, in this case, the transmission G has a separating clutch K0 by which the input shaft GW1 is disconnectable from engagement with a connection shaft AN2 of the transmission G. Therefore, the electric machine EM2 can drive the input shaft GW1 without entraining an internal combustion engine connected to the connection shaft AN2.

The transmission G according to FIG. 7 also differs from the transmission represented in FIG. 6 with respect to the power transmission from the input shaft GW1 to the oil pump P. Instead of the sprocket KT, a spur gear drive ST is provided in this case. An intermediate gear of the spur gear drive ST, which is rotatably supported on the transmission housing GG, intermeshes with a gearwheel connected to the input shaft GW1 and with the external gearing AV, which is connected to the third element E3 of the planetary gear set RS of the electric drive unit E.

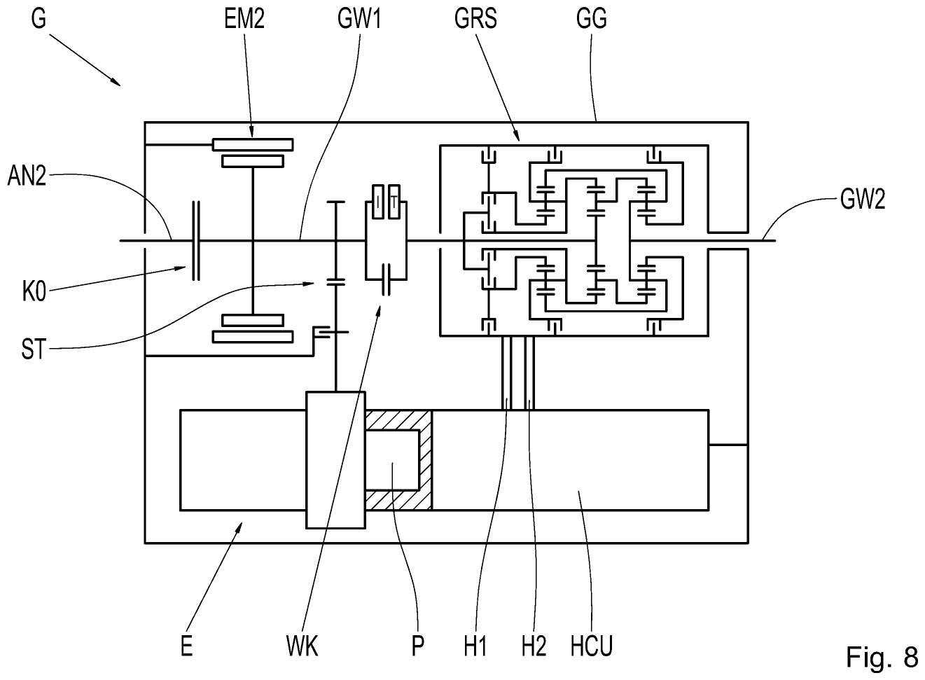

FIG. 8 shows a schematic of a transmission G for a motor vehicle, which essentially corresponds to the transmission represented in FIG. 7 except that the transmission G has a torque converter having a pump side I and a turbine side T in this case. The pump side I is connected to the input shaft GW1. The turbine side T is connected to an input of the transmission gear set GRS. The pump side I and the turbine side T are connectable to one another by engaging a torque converter lockup clutch WK.

The variants of the transmission G described in FIGS. 6-8 are to be considered merely by way of example. Each of the variants could also be without a separating clutch K0 and/or without the electric machine EM2. The transmission gear set GRS can utilize multiple planetary gear sets and/or one or multiple countershaft systems in order to implement gears. The electric drive unit E is usable in different transmission versions, for example, in an automatic transmission, an automated transmission, or in a dual clutch transmission.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

E electric drive unit
EM electric motor
S stator unit
SP stator core
V molding compound
R rotor
RW rotor shaft
EE electronic control unit
ET carrier element
EEG ground connection
K heat sink
X electrical conductor
X2 electrical conductor
LT bearing carrier
L1 bearing
L2 bearing
L3 bearing
B bolt
H sleeve
TE separating element
P pump
PG pump housing
PR impeller
RS planetary gear set
E1 first element
E2 second element
E3 third element
AW oil pump drive shaft
AV external gearing
G transmission
GW1 input shaft
GW2 output shaft
GRS transmission gear set
GG housing
EM2 second electric machine
HCU hydraulic control unit
H1, H2 hydraulic lines
KT sprocket
ST spur gear drive
AN2 connection shaft
K0 separating clutch
I pump side
T turbine side
WK torque converter lockup clutch

1.-19: (canceled)

20. An electric drive unit (E), comprising:
an electric motor (EM) comprising a stator unit (S) and a rotor (R); and
an electronic control unit (EE) configured for open-loop control of the electric motor (EM),
wherein the electronic control unit (EE) is mounted on an electrically insulating carrier element (ET),
wherein the carrier element (ET) is attached to the stator unit (S), and
wherein the stator unit (S) comprises a stator core (SP), the stator core (SP) being electrically conductively connected to a ground connection (EEG) of the electronic control unit (EE).

21. The electric drive unit (E) of claim 20, further comprising a metallic heat sink (K) configured for cooling the electronic control unit (EE), wherein the ground connection (EEG) is electrically conductively connected to the heat sink (K).

22. The electric drive unit (E) of claim 21, wherein the electrically conductive connection between the stator core (SP) and the ground connection (EEG) extends through the heat sink (K).

23. The electric drive unit (E) of claim 22, wherein the electrically conductive connection between the stator core (SP) and the ground connection (EEG) further comprises an electrical conductor (X), the electrical conductor (X) electrically conductively connecting the stator core (SP) and the heat sink (K).

24. The electric drive unit (E) of claim 23, wherein the electrical conductor (X) comprises at least one metallic sheet-metal strip or a wire section.

25. The electric drive unit (E) of claim 21, wherein the carrier element (ET) is arranged between the heat sink (K) and the stator unit (S).

26. The electric drive unit (E) of claim 20, further comprising a metallic bearing carrier (LT) and a rotor shaft (RW), the rotor shaft (RW) being rotatably mounted in the bearing carrier (LT),
wherein the rotor (R) of the electric motor (EM) is connected to the rotor shaft (RW), and
wherein the bearing carrier (LT) is electrically insulated from the stator core (SP).

27. The electric drive unit (E) of claim 26, wherein the carrier element (ET) and the electronic control unit (EE) are arranged between the stator unit (S) and the bearing carrier (LT).

28. The electric drive unit (E) of claim 27, wherein the electronic control unit (EE) is arranged on a front-side of the carrier element (ET) closest to the bearing carrier (LT).

29. The electric drive unit (E) of claim 26, wherein the bearing carrier (LT) contacts the electronic control unit (EE) such that the bearing carrier (LT) and the electronic control unit (EE) are thermally conductive with each other.

30. The electric drive unit (E) of claim 26, wherein the stator unit (S) comprises an electrically insulating molding compound (V), the electrically insulating molding compound (V) at least partially enclosing the stator core (SP).

31. The electric drive unit (E) of claim 30, wherein the carrier element (ET) is attached to the molding compound (V).

32. The electric drive unit (E) of claim 31, wherein the stator core (SP) is electrically insulated from the bearing carrier (LT) by the molding compound (V).

33. The electric drive unit (E) of claim 26, wherein the stator core (SP) is insulated from the bearing carrier (LT) by a separate electrically insulating separating element (TE).

34. The electric drive unit (E) of claim 26, wherein the stator core (SP) is insulated from the bearing carrier (LT) by the carrier element (ET).

35. The electric drive unit (E) of claim 20, wherein the rotor (R) of the electric motor (EM) is an internal rotor, and
wherein the stator unit (S) does not comprise a housing.

36. A pump drive, comprising the electric drive unit (E) of claim 20.

37. A transmission (G) for a motor vehicle, comprising a pump (P) and the electric drive unit (E) of claim 20 configured for driving the pump (P).

38. The transmission (G) of claim 37, wherein the rotor (R) of the electric drive unit (E) is connected to an impeller (PR) of the pump (P) directly or via a planetary gear set (RS).
